(19) United States
(12) Patent Application Publication
(10) Pub. No.: US 2021/0323126 A1
(43) Pub. Date: Oct. 21, 2021

(54) TORQUE SOCKET

(71) Applicant: Wei-Chieh CHUANG, New Taipei City (TW)

(72) Inventor: Wei-Chieh CHUANG, New Taipei City (TW)

(21) Appl. No.: 17/204,054

(22) Filed: Mar. 17, 2021

(30) Foreign Application Priority Data
Apr. 20, 2020 (TW) 109204645

(51) Int. Cl. B25B 23/142; B25B 23/00; B25B 23/12

(52) U.S. Cl. CPC B25B 23/1427; B25B 23/12; B25B 23/0035

(57) ABSTRACT

A torque socket includes: a shaft rod, having two sides thereof axially extended with an insertion tenon and a core shaft, wherein the core shaft is axially formed with a shaft hole; and a shaft cylinder, having two sides thereof respectively formed with a shaft slot and a sleeve slot allowing a drive head to be inserted, wherein the shaft cylinder has a recess which is radially formed with a ball hole allowing a ball member to be disposed, the recess has an elastic tube member radially formed with a receiving hole allowing the ball member to be received, so that an elastic effect of the elastic tube member can be provided to the ball member for allowing the ball member to constantly protrude from the sleeve slot, and the ball member is able to be elastically latched in a latch slot of the drive head.

### BACKGROUND OF THE INVENTION

### Field of the Invention

The present invention relates to a torque socket, especially to a torque socket having functions of allowing a drive head to be rapidly connected and preventing the drive head from being released, wherein one end of the torque socket is sleeved with a manual, a pneumatic or an electric rotation tool and another end thereof is sleeved with the drive head.

### Description of the Related Art

A screwdriver is mainly composed of a handgrip and a drive rod having a drive head, the drive head is generally categorized into a flat type or a cross type for matching with a flat or a cross recess formed at the top end of a screw, thereby enabling the screw to be locked or released. Because the drive head of the screwdriver is formed with a fixed shape and dimension, thus another drive head having a different shape and dimension cannot be utilized for replacement.

In view of the disadvantage of the above-mentioned screwdriver, the skilled people in the art have developed a manual tool allowing the drive head to be replaced, for example a wrench, the wrench is sleeved with a socket, an insertion slot at the bottom end of the socket is able to be sleeved with a drive head having different shapes and dimensions, thereby being suitable to be applied in various types of screws. As such, the socket is only served as a torque transferring tool, and the socket itself is not provided with any quantified torque mechanism.

For preventing a user from utilizing a rotation tool, for example a screwdriver or a wrench, to rotate a connecting member, for example a screw, with a rotating force greater than an allowing range of the screw and causing threads of the screw to be damaged, thus a transmission structure composed of a spring and a steel ball is utilized for limiting an output torque of the screwdriver, when the screwdriver is in use and the torque is overly larger, the steel ball would be separated from the spring for allowing the screwdriver to be released from a drive head thereof, so that the screwdriver and the drive head thereof form an idle rotating status for controlling the screwdriver to output a quantified torque, thereby preventing the connecting member from being damaged.

The screwdriver having the transmission structure composed of the spring and the steel ball can control the outputted quantified torque, but only a point contacting status is established when the steel ball being released from the spring, thus the components are fragile and very easy to be deformed and damaged, and the limited outputted torque value is relatively unstable. In addition, because the above-mentioned screwdriver is provided with the transmission structure composed of the spring and the steel ball, the dimension of the screwdriver is unable to be effectively reduced, thus the screwdriver is not suitable to be applied in the locking operation of a precision instrument.

Moreover, a sleeve slot of a conventional torque socket is used for allowing a drive head to be disposed, but the drive head and the sleeve slot cannot be tightly connected due to the manufacturing tolerance or wearing, thus the drive head may be released from the sleeve slot, and a poor operating performance may be caused during the actual operation. As such, the skilled people in the art has developed a means of disposing a magnet at an inner end of the sleeve slot for magnetically attracting the drive head so as to prevent the drive head from being released from the sleeve slot; however, a drive head made of a non-magnetic-conducting material, for example iron, is unable to be provided with the magnetic attracting effect by utilizing the magnet, so that a situation of releasing is still needed to be concerned. Accordingly, the above-mentioned disadvantages shall be improved.

### SUMMARY OF THE INVENTION

One primary objective of the present invention is to provide a torque socket, which has functions of allowing a torque of a drive head to be adjustable and allowing the drive head to be rapidly connected and avoided the drive head from being released, so that the drive head can be prevented from being released from a sleeve slot of the torque socket.

For achieving said objective, one technical solution provided by the present invention is to provide a torque socket, which includes: a shaft rod, having two sides thereof axially extended with an insertion tennon allowing a rotation tool to be connected and a core shaft, wherein the core shaft is axially formed with a shaft hole, an outer circumferential surface of the core shaft is axially formed with at least one cut groove communicated with the shaft hole and radially formed with a first friction surface; and a shaft cylinder, having two sides thereof respectively formed with a shaft slot allowing the core shaft to be disposed and a sleeve slot allowing a drive head to be inserted, wherein an inner side of the shaft slot is radially formed with a second friction surface which is in contact with the first friction surface, an outer circumferential surface of the shaft cylinder is formed with a recess, the recess is radially formed with a ball hole communicated with the sleeve slot and allowing a ball member to be disposed, the recess is further provided with an elastic tube member, and the elastic tube member is radially formed with a receiving hole having a dimension smaller than a dimension of the ball member and allowing the ball member to be received, so that an elastic effect of the elastic tube member is able to be provided to the ball member in the ball hole for allowing the ball member to constantly protrude from the sleeve slot, and the ball member is able to be elastically latched in a latch slot of the drive head.

According to one embodiment of the present invention, an inner circumferential surface of the shaft hole is formed with a conical abutting surface and a combination segment, and an adjustment member is disposed in the shaft hole, an outer circumferential surface of the adjustment member is respectively formed with a conical top connecting head which is in contact with the abutting surface and an engaging segment engaged with the combination segment; and a communicating hole is formed between the shaft slot and the sleeve slot of the shaft cylinder; when the adjustment member is rotated, the engaging segment and the top connecting head are respectively and axially moved along the combination segment and the abutting surface, thus an outer dimension of the core shaft is altered, and a contact area of the first friction surface and the second friction surface is adjusted for allowing a torque value to be adjusted to a preset torque value.

According to another embodiment of the present invention, a sealing plug is provided for sealing the communicating hole after a torque value is adjusted to a preset torque value.

According to another embodiment of the present invention, an end surface of the engaging segment is axially formed with a rotation hole having a non-circular cross section and capable of being rotated through being driven by a tool.

According to another embodiment of the present invention, the insertion tenon and the sleeve slot have non-circular cross sections, and the core shaft and the shaft slot have circular cross sections.

According to another embodiment of the present invention, an outer circumferential surface of the core shaft is formed with a convex latch part, and an inner circumferential surface of the shaft slot is formed with a buckle part corresponding to the latch part and allowing the latch part to be latched and buckled.

According to another embodiment of the present invention, a magnet is disposed in the sleeve slot.

According to another embodiment of the present invention, the core shaft is disposed with an oil storing zone arranged at a periphery of the at least one cut groove.

According to another embodiment of the present invention, an indication ring used for indicating a torque value is disposed on an outer circumferential surface of the shaft cylinder.

According to another embodiment of the present invention, the core shaft is sleeved with an elastic member abutted against the flange and a mobile ratchet axially and annularly disposed with a plurality of unidirectional mobile ratchet teeth; an accommodation slot allowing the mobile ratchet to be accommodated is formed between the shaft slot and the second friction surface, a fixed ratchet axially and annularly disposed with a plurality of unidirectional fixed ratchet teeth is fixed in the accommodation slot and the fixed ratchet is mutually engaged with the mobile ratchet; when the core shaft rotates in the shaft slot and the preset torque value is exceeded, the core shaft forms an idle rotating status in the shaft slot, the mobile ratchet teeth are engaged and rotated along the fixed ratchet teeth for allowing the mobile ratchet to axially and elastically move so as to generate a sound.

According to another embodiment of the present invention, the mobile ratchet is radially formed with at least one position limiting slot, a position limiting pin is allowed to pass the at least one position limiting slot and inserted in a first pin hole radially preformed on the core shaft, thereby allowing the mobile ratchet to axially and elastically move on the core shaft; and the fixed ratchet is radially formed with at least one positioning slot, a positioning pin is allowed to pass a second pin hole radially preformed in the shaft slot and inserted into the at least one positioning slot, so that the fixed ratchet is prevented from rotating in the accommodation slot.

According to one another embodiment of the present invention, the elastic member is a spring or an elastic disk.

### BRIEF DESCRIPTION OF THE DRAWINGS

FIG. 1 is a perspective exploded view illustrating the torque socket according to the present invention;

FIG. 2 is another perspective exploded view illustrating the torque socket according to the present invention;

FIG. 3 is a perspective view illustrating the assembly of the torque socket according to the present invention;

FIG. 4 is a cross sectional view of FIG. 3 taken along an A-A line;

FIG. 5 is a cross sectional view of FIG. 3 taken along a B-B line;

FIG. 6 is a perspective exploded view illustrating the torque socket and the drive head according to the present invention;

FIG. 7 is a perspective view illustrating the assembly of the torque socket and the drive head according to the present invention; and

FIG. 8 is a cross sectional view illustrating the assembly of the torque socket and the drive head according to the present invention.

### DETAILED DESCRIPTION OF THE PREFERRED EMBODIMENTS

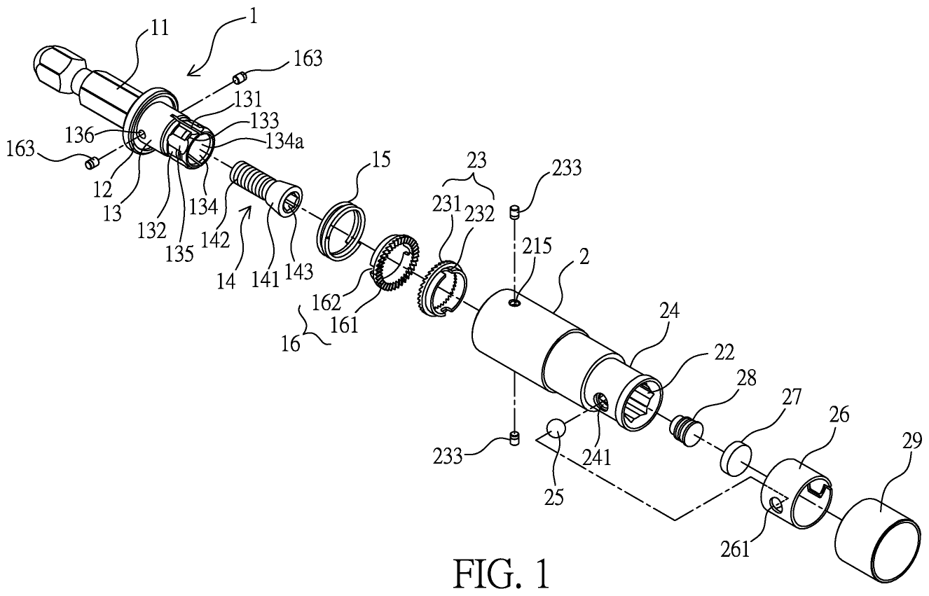

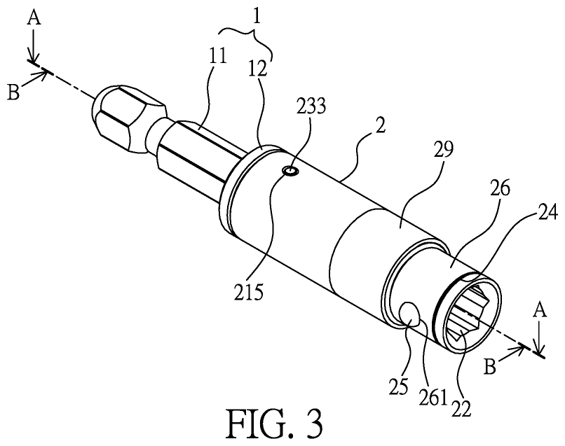

Please refer from FIG. 1 to FIG. 5, a torque socket having a shaft rod 1 and a shaft cylinder 2 is disclosed.

The shaft rod 1 is formed as a rod member, one axial side thereof has an insertion tenon 11 having a cross section formed in a non-circular shape, for example a hexagonal shape, a flange 12 is radially formed at an inner side of the insertion tenon 11, so that two sides of the flange 12 can be arranged to be adjacent to the shaft cylinder 2 and connecting rod (known as prior art and not shown in figures) at a bottom end of a handgrip of a rotation tool, for example a screwdriver. Another side of the flange 12 is extended with a core shaft 13 having a circular cross section, an outer circumferential surface of the core shaft 13 is axially formed with at least one cut groove 131, thereby providing a proper elasticity to the core shaft 13. In addition, the outer circumferential surface of the core shaft 13 is formed with a concave first friction surface 132 and a convex latch part 133. Moreover, the core shaft 13 is axially formed with a shaft hole 134, and the shaft hole 134 is communicated with the at least one cut groove 131.

In addition, the core shaft 13 is respectively disposed with an oil storing zone 135 formed through a milling means and arranged at a periphery of the at least one cut groove 131 for allowing a lubricating oil to be stored, so that a smooth operating function can be provided while the core shaft 13 rotates in the shaft cylinder 2.

Moreover, for allowing the first friction surface 132 of the core shaft 13 to be provided with a radially expanding or retracting function, an inner circumferential surface at one side (an inner side) of the shaft hole 134 is formed with a conical abutting surface 134a, a middle segment thereof is formed as a combination segment 134b, for example an inner threaded, another side (an outer side) of the shaft hole 134 allows a tool, for example a hexagonal wrench, to be inserted.

The shaft hole 134 has an adjustment member 14, two ends defined at an outer circumferential surface of the adjustment member 14 are respectively formed with a conical top connecting head 141 and an engaging segment 142, for example an outer thread. An end surface of the engaging segment 142 is axially formed with a rotation hole 143 (shown in FIG. 1) having a non-circular cross section, for example a hexagonal cross section. When being assembled, a user inserts the adjustment member 14 into the shaft hole 134 and rotates the top connecting head 141, so that the engaging segment 142 is threaded with the combination segment 134b, and the top connecting head 141 is accommodated in the abutting surface 134a, thereby allowing the two conical surfaces to be in a contacting status.

Furthermore, the core shaft 13 is sequentially sleeved, at the inner side of the flange 12, with an elastic member 15, for example a spring or an elastic disk, and a mobile ratchet 16 capable of axially moving on the core shaft 13, an inner side and an outer side of the mobile ratchet 16 are respectively and axially and annularly disposed with a plurality of unidirectional mobile ratchet teeth 161 and radially formed with at least one position limiting slot 162, a position limiting pin 163 is allowed to pass the position limiting slot 162 and inserted in a first pin hole 136 radially preformed on the core shaft 13, thereby allowing the mobile ratchet 16 to axially and elastically move on the core shaft 13.

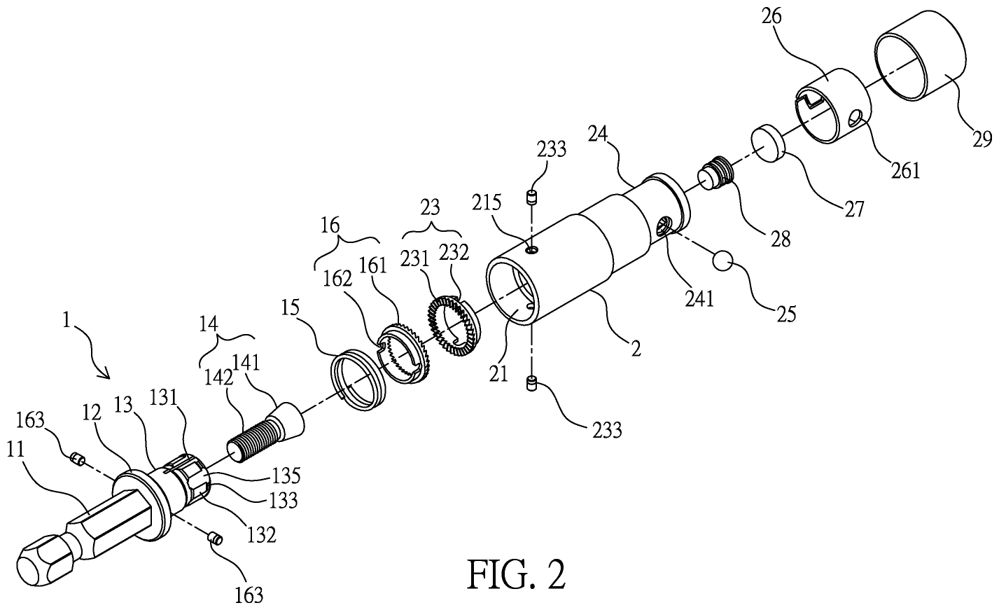

The shaft cylinder 2 is formed as a hollow cylindrical member, two axial sides thereof are respectively formed with a shaft slot 21 (show in FIG. 2) having a circular cross section and a sleeve slot 22 having a non-circular cross section, for example an hexagonal cross section. The dimension of the shaft slot 21 is slightly smaller than the core shaft 13, and the above two are mounted and connected with a tightening means so as to form a pivotal shaft structure having stopping and positioning effects. Wherein, the shaft slot 21 is formed as a stepped circular hole, an inner circumferential surface thereof is respectively formed with a second friction surface 211 and a buckle part 212 corresponding to the first friction surface 132 and the latch part 133 of the core shaft 13, the latch part 133 is latched and buckled with the buckle part 212, thereby preventing the shaft rod 1 and the shaft cylinder 2 from being axially releasing. The second friction surface 211 and the first friction surface 132 are tightly arranged, so that a torque is generated between the second friction surface 211 and the first friction surface 132.

An accommodation slot 213 allowing the mobile ratchet 16 to be accommodated is formed between an opening at an outer side of the shaft slot 21 and the second friction surface 211, a fixed ratchet 23 is fixed in the accommodation slot 213, and an inner side of the fixed ratchet 23 is abutted against a block edge 214 radially formed in the accommodation slot 213, an outer side and an inner side of the fixed ratchet 23 are respectively and axially and annularly disposed with a plurality of unidirectional fixed ratchet teeth 231 and radially formed with at least one positioning slot 232, a positioning pin 233 is allowed to pass a second pin hole 215 radially preformed on an outer circumferential surface of the shaft slot 21 and inserted into the positioning slot 232, so that the fixed ratchet 23 is fastened in the accommodation slot 213 and prevented from rotating.

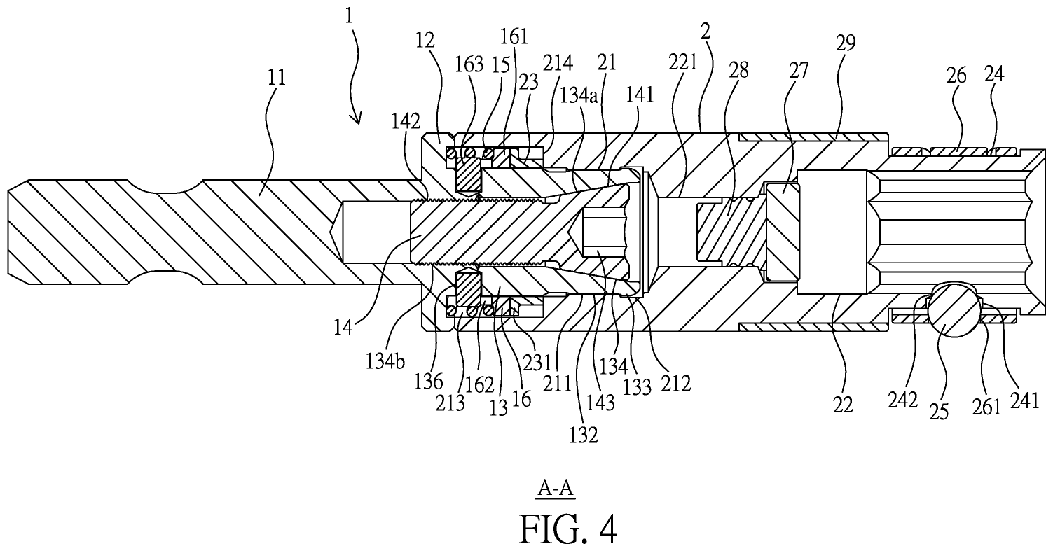

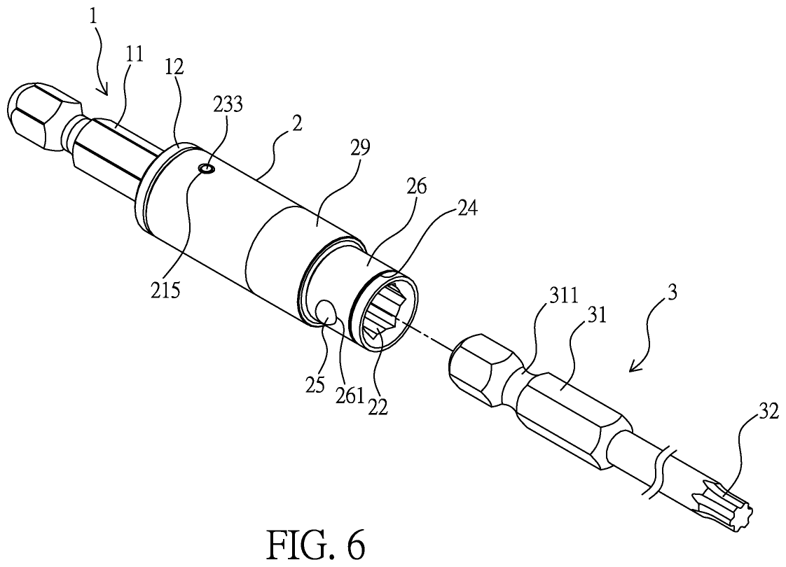

As shown in FIG. 6, the sleeve slot 22 allows a sleeve rod 31 of a drive head 3 to be sleeved so as to be positioned. For providing a rapidly sleeving and an anti-releasing functions to the sleeve rod 31 relative to the sleeve slot 22, the sleeve slot 22 has an annular recess 24 corresponding to the outer circumferential surface of the shaft cylinder 2, the recess 24 is radially formed with a ball hole 241 communicated with the sleeve slot 22, and a ball member 25, for example a steel ball, is disposed in the ball hole 241. Wherein, a stop edge 242 (shown in FIG. 4), formed in a chamfered shape, is formed at a bottom end of the ball hole 241, thereby preventing the ball member 25 from falling into the sleeve slot 22. The recess 24 is further sleeved with an elastic tube member 26, and the elastic tube member 26 is radially formed with a receiving hole 261 having a dimension, for example a diameter thereof being smaller than that of the ball member 25, and one end of the ball member 25 is received in the receiving hole 261; the elastic tube member 26 is able to provide a radially retracting elasticity because two ends of the elastic tube member 26 are not connected, so that an elastic effect of the elastic tube member 26 can be provided to the ball member 25 in the ball hole 241 for allowing the ball member 25 to constantly protrude from the sleeve slot 22.

Moreover, a magnet 27 is mounted in the sleeve slot 22, thus the magnet 27 is able to be sleeved with the sleeve slot 22 via a magnetically attracting means and to provide a magnetic force to the drive head 3 made of a magnetic conducting material, for example iron, so that the drive head 3 can attract a connecting member, for example a screw, made of a magnetic conducting material.

Moreover, a communicating hole 221 is formed between the shaft slot 21 and the sleeve slot 22, when the torque socket is assembled, only a tool, for example a hexagonal wrench, is required to pass the sleeve slot 22 and the communicating hole 211 for being inserted in the rotation hole 143 for rotations, the adjustment member 14 is axially moved in the shaft hole 134 for allowing the top connecting head 141 to move along the abutting surface 134a, thus the outer dimension of the core shaft 13 is altered, for example being radially expanded or retracted, and a contact area of the first friction surface 132 and the second friction surface 211 can be adjusted for allowing a torque value to be adjusted to a preset torque value, then the tool is retracted from the communicating hole 221 and the sleeve slot 22, and a sealing plug 28 is provided for sealing the communicating hole 221, the magnet 27 is disposed in the sleeve slot 22 for preventing a user from adjusting the torque value of the torque socket according to his/her free wills.

Moreover, an indication ring 29 used for indicating a torque value is disposed, for example being adhered, on the outer circumferential surface of the shaft cylinder 2, the indication ring 29 is used for indicating the torque value of the torque socket, for example 0.6 Nm (Newton-meter), 0.9 Nm, 1.2 Nm, 1.4 Nm, 2.0 Nm, 3.0 Nm, 5.0 Nm, 5.5 Nm, and etc., thus the torque socket having different torque values can adopt the indication ring 29 having different colors for the purpose of indication, for example, the 0.6 Nm torque socket adopts the red indication ring 29, and the 0.9 Nm torque socket adopts the yellow indication ring 29.

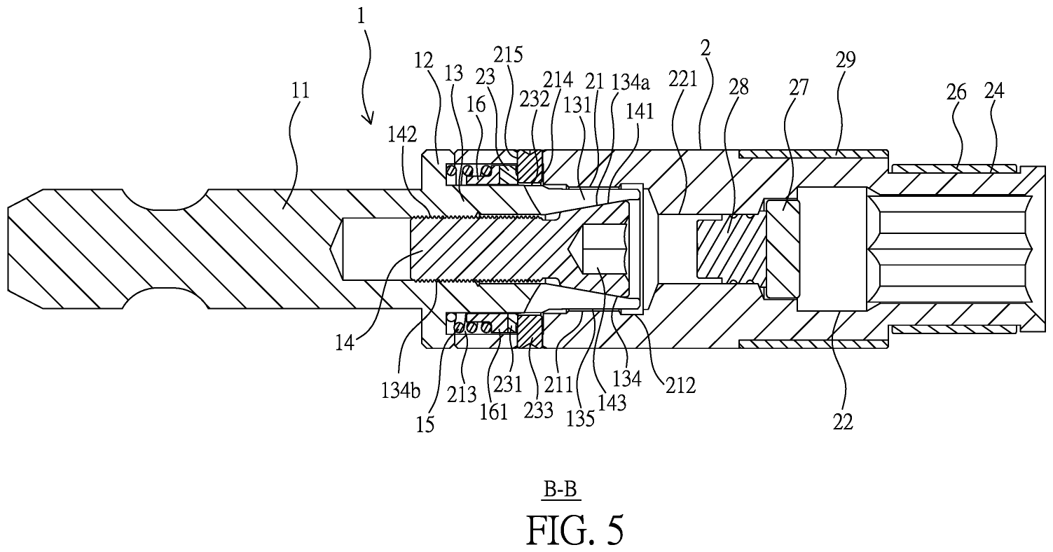

As shown from FIG. 1 to FIG. 5, when the torque socket is desired to be assembled, the core shaft 13 of the shaft rod 1 is inserted into the shaft slot 21 of the shaft cylinder 2, and the latch part 133 of the core shaft 13 is latched and buckled with the buckle part 212 of the shaft slot 21, so that the shaft rod 1 and the shaft cylinder 2 can be prevented from being axially separated. At this moment, the mobile ratchet 16 sleeved with the core shaft 13 is provided with an energy releasing effect supplied by the elastic member 15, so that the unidirectional mobile ratchet teeth 161 of the mobile ratchet 16 and the fixed ratchet teeth 231 of the fixed ratchet 23 are mutually engaged, thereby structuring the torque socket shown in FIG. 4 and FIG. 5.

When a torque deviation is desired to be adjusted, the adjusting and assembling operation can be processed with respect to the aforesaid means, therefore no further illustration is provided.

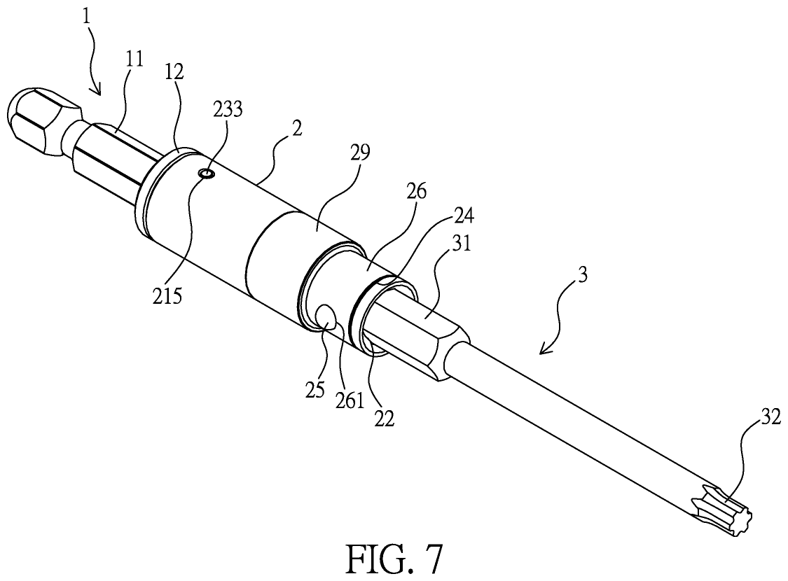

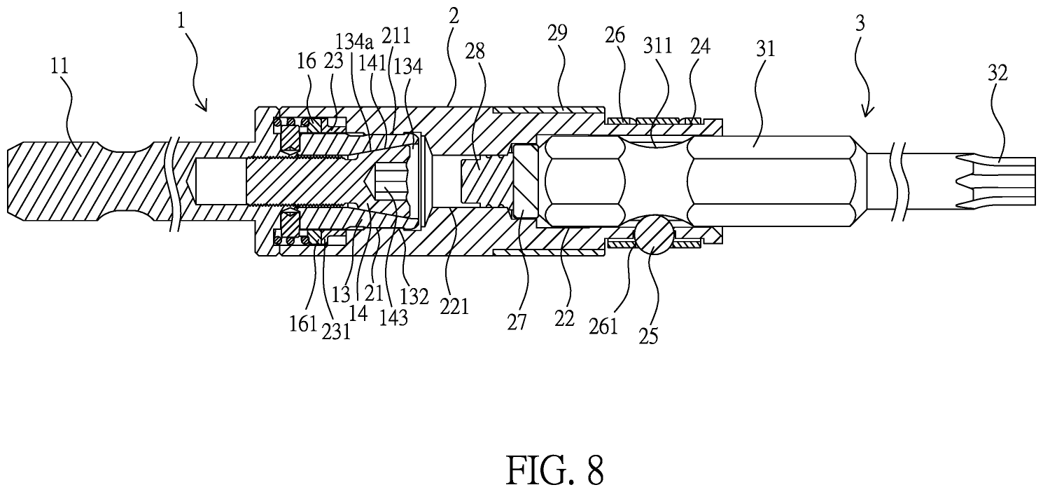

Please refer from FIG. 6 to FIG. 8, the insertion tenon 11 of the shaft rod 11 is inserted in an insertion slot (known as prior art and not shown in figures) at a connection rod at a bottom end of a handgrip of a rotation tool, for example a manual screwdriver; wherein, the rotation tool is not limited to the handgrip of the manual screwdriver, in other words the torque socket of the present invention can also be applied to a pneumatic or an electric rotation tool, and anticipated locking or releasing functions can also be achieved. The sleeve slot 22 of the shaft cylinder 2 is sleeved with a drive head 3, one end of the drive head 3 is disposed with a sleeve rod 31, another end thereof is formed as a tenon head 32 having a flat shape, a cross shape or any other geometrical shape according to actual practices, wherein the sleeve rod 31 is radially and annularly formed with a latch slot 311. When the drive head 3 and the torque socket are assembled, the sleeve rod 31 is inserted in the sleeve slot 22 for forming a combining status as shown in FIG. 7. At this moment, the ball member 25 in the ball hole 241 is provided with the elastic effect supplied by the elastic tube member 26 for being latched and buckled in the latch slot 311 (as shown in FIG. 8), so that the drive head 3 can be prevented from being axially released from the sleeve slot 22, and operations of screwing in or screwing out the connecting member, for example the screw, can be smoothly processed.

When the torque socket of the present invention is desired to be operated, the tenon head 32 of the drive head 3 is firstly aimed at an object to be combined, for example a connecting member, such as a recess formed at a top end of the screw, arranged at a periphery of a monitor lens, the rotation tool is rotated by a hand of the user, so that the shaft rod 1 is able to drive the shaft cylinder 2 and the drive head 3 to synchronously rotate for processing a screwing and locking operation; during the screwing process, if the preset torque value of the torque socket does not exceed, the screw can be continuously screwed in, when the screw is rotated and positioned (tightened) or the preset torque value has been exceeded, the core shaft 13 forms an idle rotating status in the shaft slot 21, the mobile ratchet teeth 161 of the mobile ratchet 16 sleeved with the core shaft 13 are engaged and rotated along the fixed ratchet teeth 231 of the fixed ratchet 23 and axially and elastically moved, so that a sound is generated for reminding the user that the screw is in tightened status or the preset torque value has been reached, thereby preventing the lens from being squeezed and damaged due to the screw being overly locked and tightened.

Based on what has been disclosed above, advantages achieved by the present invention are as follows. The ball member in the ball hole is provided with the elastic effect supplied by the elastic tube member for being latched and buckled in the latch slot of the drive head, so that the drive head can be prevented from being axially released from the sleeve slot, and operations of screwing in or screwing out the connecting member, for example the screw, can be smoothly processed. In addition, the adjustment member can be axially moved in the core shaft for allowing altering the outer dimension of the core shaft, for example being radially expanded or retracted, and the contact area of the core shaft and the shaft slot can be adjusted for allowing the torque value to be adjusted to the preset torque value. Moreover, with a non-return ratchet structure oppositely disposed between the core shaft and the shaft slot, the torque can be prevented from being overly greater than the tolerable range of the connecting member due to the improper screwing, so that the core shaft can be in the idle rotating status in the shaft slot, and the reminding sound can be generated by the non-return ratchet structure, thereby avoiding unnecessary lost. Furthermore, the mobile ratchet and the fixed ratchet of the non-return ratchet structure are both unidirectional and capable of being mutually engaged, so that a non-return function is provided for facilitating the loosening operation of the connecting member; accordingly, the torque socket provided by the present invention is novel and more practical in use comparing to prior art.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A torque socket, including:
a shaft rod, having two sides thereof axially extended with an insertion tennon allowing a rotation tool to be connected with and a core shaft, wherein said core shaft is axially formed with a shaft hole, an outer circumferential surface of said core shaft is axially formed with at least one cut groove communicated with said shaft hole and radially formed with a first friction surface; and
a shaft cylinder, having two sides thereof respectively formed with a shaft slot allowing said core shaft to be disposed and a sleeve slot allowing a drive head to be inserted, wherein an inner side of said shaft slot is radially formed with a second friction surface which is in contact with said first friction surface, an outer circumferential surface of said shaft cylinder is formed with a recess, said recess is radially formed with a ball hole communicated with said sleeve slot and allowing a ball member to be disposed, said recess is further provided with an elastic tube member, and said elastic tube member is radially formed with a receiving hole having a dimension smaller than a dimension of said ball member and allowing said ball member to be received, so that an elastic effect of said elastic tube member is able to be provided to said ball member in said ball hole for allowing said ball member to constantly protrude from said sleeve slot, and said ball member is elastically latched in a latch slot of said drive head.

2. The torque socket as claimed in claim 1, wherein an inner circumferential surface of said shaft hole is formed with a conical abutting surface and a combination segment, and an adjustment member is disposed in said shaft hole, an outer circumferential surface of said adjustment member is respectively formed with a conical top connecting head which is in contact with said conical abutting surface and an engaging segment engaged with said combination segment; and a communicating hole is formed between said shaft slot and said sleeve slot of said shaft cylinder; when said adjustment member is rotated, said engaging segment and said conical top connecting head are respectively and axially moved along said combination segment and said conical abutting surface, thus an outer dimension of said core shaft is altered, and a contact area of said first friction surface and said second friction surface is adjusted for allowing a torque value to be adjusted to a preset torque value.

3. The torque socket as claimed in claim 2, wherein a sealing plug is provided for sealing said communicating hole after said torque value is adjusted to said preset torque value.

4. The torque socket as claimed in claim 1, wherein an end surface of said engaging segment is axially formed with a rotation hole having a non-circular cross section and capable of being rotated through being driven by a tool.

5. The torque socket as claimed in claim 1, wherein said insertion tenon and said sleeve slot have non-circular cross sections, and said core shaft and said shaft slot have circular cross sections.

6. The torque socket as claimed in claim 1, wherein an outer circumferential surface of said core shaft is formed with a convex latch part, and an inner circumferential surface of said shaft slot is formed with a buckle part corresponding to said latch part and allowing said latch part to be latched and buckled.

7. The torque socket as claimed in claim 1, wherein a magnet is disposed in said sleeve slot.

8. The torque socket as claimed in claim 1, wherein said core shaft is disposed with an oil storing zone arranged at a periphery of said at least one cut groove.

9. The torque socket as claimed in claim 1, wherein an indication ring used for indicating a torque value is disposed on an outer circumferential surface of said shaft cylinder

10. The torque socket as claimed in claim 1, wherein said core shaft is sleeved with an elastic member abutted against a flange and a mobile ratchet axially and annularly disposed with a plurality of unidirectional mobile ratchet teeth; an accommodation slot allowing said mobile ratchet to be accommodated is formed between said shaft slot and said second friction surface, a fixed ratchet axially and annularly disposed with a plurality of unidirectional fixed ratchet teeth is fixed in said accommodation slot and said fixed ratchet is mutually engaged with said mobile ratchet; when said core shaft rotates in said shaft slot and said preset torque value is exceeded, said core shaft forms an idle rotating status in said shaft slot, said mobile ratchet teeth are engaged and rotated along said fixed ratchet teeth for allowing said mobile ratchet to axially and elastically move so as to generate a sound.

11. The torque socket as claimed in claim 10, wherein said mobile ratchet is radially formed with at least one position limiting slot, a position limiting pin is allowed to pass said at least one position limiting slot and inserted in a first pin hole radially preformed on said core shaft, thereby allowing said mobile ratchet to axially and elastically move on said core shaft; and said fixed ratchet is radially formed with at least one positioning slot, a positioning pin is allowed to pass a second pin hole radially preformed in said shaft slot and inserted into said at least one positioning slot, so that said fixed ratchet is prevented from rotating in said accommodation slot.

12. The torque socket as claimed in claim 10, wherein said elastic member is a spring or an elastic disk.
